(19) United States
(12) Patent Application Publication
(10) Pub. No.: US 2017/0102172 A1
(43) Pub. Date: Apr. 13, 2017

(54) Wearable Device

(71) Applicant: HUAQIN TELECOM TECHNOLOGY CO., LTD., Shanghai (CN)

(72) Inventors: Mingxing Fu, Shanghai (CN); Dong Pang, Shanghai (CN)

(73) Assignee: Huaqin Telecom Technology Co., Ltd., Shanghai (CN)

(21) Appl. No.: 15/117,106

(22) PCT Filed: Nov. 18, 2014
(86) PCT No.: PCT/CN2014/091356

§ 371 Date: Aug. 5, 2016

(30) Foreign Application Priority Data
Jul. 3, 2014 (CN) 201410314745.5
Jul. 3, 2014 (CN) 201420365879.5

(51) Int. Cl. F25B 21/04; G04B 47/06; G06F 1/16

(52) U.S. Cl. CPC F25B 21/04; G06F 1/163; G04B 47/068; F25B 2321/0212; F25B 2321/023

(57) ABSTRACT

A wearable device, comprising at least one contact area (11) for contacting a wearing object, a temperature detecting circuit (12), at least one temperature regulating module and a control chip (16). The temperature detecting circuit (12) is used to detect the temperature of the contact area (11) when an event occurs as a first temperature; the control chip (16) is used to control the temperature regulating module to change the temperature during a preset time period from the time the event occurs, such that the temperature of the contact area (11) changes based on the first temperature as an alert of event occurrence. The wearable device can alert a user to event occurrence by regulating a temperature, without causing discomfort to the user, and can provide various types of alerting modes for correspondingly alerting the user to occurrence of different types of events.

The present application requests priorities of Chinese patent application CN201420365879.5 filed on Jul. 3, 2014 and Chinese patent application CN201410314745.5 filed on Jul. 3, 2014. The above applications are entirely incorporated by reference.

### FIELD OF INVENTION

The present invention relates to a wearable device.

### PRIOR ARTS

Wearable device denotes a portable device directly worn or integrated into the clothes or accessories of the user. At present, the wearable device is in the form of portable accessories connectable to cell phone or various terminals with partial calculation function. The mainstream product form thereof includes watch products supported by wrist such as watch and wristband; shoe products supported by foot such as shoes, socks or other wearable devices for legs to be developed in the future; glass products supported by head such as glasses, helmet and head band; and various non-mainstream products such as intelligent costume, bag, crutch and ornament.

Wearable device is not only a hardware device, but also a device implementing powerful functions by software support and data interaction or cloud interaction. Wearable device will greatly change our life and perception.

The alert modes of the conventional wearable device mainly involve sound alert and vibration alert. The sound alert is not applicable in many situations (i.e. during the meeting, cinema). And for the vibration alert, the wearable device contacts user's skin directly, especially the intelligent glasses class of wearable device will contact some sensitive part of human body, thus the vibration will bring unpleasant experience to user.

### Content of the Present Invention

The technical problem to be solved by the present invention is to overcome the defect that the alert modes of the conventional wearable device will bring inconvenience and unpleasant experience to user. To solve this technical problem, the present invention provides a wearable device with quiet and comfortable alert mode for alerting events.

The present invention solves the above technical problem by the following technical solution: a wearable device, comprising at least one contact area for contacting a wearing object, a temperature detecting circuit, at least one temperature regulating module and a control chip;
the temperature detecting circuit is configured to detect the temperature of the contact area when events happen as a first temperature;
the control chip is configured to, within a preset interval since events happen, control the temperature regulating module to change the temperature of the contact area on the basis of the first temperature to alert events happening.

The wearable device may be an intelligent watch or a pair of intelligent glasses, and the contact area can be contacted with user's skin, to make user sense the change of temperature of the wearable device. Both the highest temperature and the lowest temperature achieved at the contact area fall within the acceptable temperature for human body.

To make user easier to sense the change of temperature, the wearable device of the present application changes temperature based on the temperature when events happen, wherein the temperature when events happen is obtained by the temperature detecting circuit, and thus able to provide user with a temperature difference to make user sense the change of temperature conveniently.

The present application can provide several alert modes, that is to say, by making temperature change on the basis of the first temperature three alert modes can be provided. The three alert modes can correspond to different types of events, and said events include foreign event and intrinsic event. For example, the wearable device is an intelligent watch capable of receiving message and answering phone call and provided with alert function notebook, and the intelligent watch can be set to make the temperature of the contact area increase on the basis of the first temperature when there is an alert of receiving a message (temperature of the contact area increases), to make the temperature of the contact area decrease on the basis of the first temperature when there is an alert of notebook (temperature of the contact area decreases), and to make the temperature of the contact area increase and decrease alternately on the basis of the first temperature when there is an alert of receiving a phone call (temperature of the contact area increases and decreases alternately).

The present application provides user with quiet and comfortable alert modes which are several, and can set different alerts for different types of events.

Preferably, the temperature regulating module includes a temperature regulating component which contacts the contact area via a heat conductive element or contacts the contact area directly.

Preferably, the wearable device further includes at least one temperature feedback circuit, and the temperature regulating module includes at least one Peltier. The temperature feedback circuit is configured to feedback the temperature of the Peltier to the control chip, and the control chip is further configured to supply power to the Peltier.

Peltier, i.e. semiconductor chilling plate, is a refrigeration technology for generating negative thermal resistance, and the advantage thereof is that there is no active component and it can be applied to some applications with limited space. By means of Peltier effect, when direct current flows through electric couple comprising two different materials in series, heat is absorbed and discharged respectively at two ends of the electric couple, and the refrigeration and heating can be achieved. Herein, the surface of the Peltier for absorbing heat is refrigeration surface, and the surface of the Peltier for discharging heat is heating surface.

Preferably, the temperature regulating module further comprises a current direction converting circuit, and the Peltier connects to the control chip via the current direction converting circuit. The control chip is configured to control the direction of the current transferred from the current direction converting circuit to the Peltier, so as to control the side of the Peltier directly contacting the contact area or contacting the contact area via the heat conductive element to switch between the refrigeration surface and the heating surface.

By means of the temperature feedback circuit, the control chip can obtain temperatures of the refrigeration surface and the heating surface of the Peltier, and thus control the supply current of the Peltier so as to control the temperature of the contact area. By means of the current direction converting circuit, the control chip can control the direction of the current transferred to the Peltier so as to achieve the switching between the heating surface and the refrigeration surface of the Peltier without moving the Peltier.

Preferably, the temperature regulating module further includes a moving device, and the control chip is configured to control the Peltier to work continuously, wherein:
when no event happens, control the moving device to retain the Peltier in such condition: the refrigeration surface of the Peltier is relatively close to a self-heating element within the wearable device, and the heating surface thereof is relatively far away from the contact area or the heat conductive element;
when events happen, control the moving device to place the Peltier to make the heating surface of the Peltier contact the contact area directly or contact the contact area via the heat conductive element.

To make the temperature of the contact area increase rapidly, the Peltier works continuously. When no event happens, the heating surface is away from the contact area such that user will not feel temperature increase. When events happen, the moving device makes the heating surface contacted the contact area directly or indirectly. Since the heating surface of the Peltier always maintains at relative higher temperature, when the heating surface contacts the contact area, heat will be rapidly transferred to the contact area, such that the temperature of the contact area increases rapidly.

Moreover, due to the characteristic of Peltier that heating by one surface and refrigerating by the other surface, when the Peltier is in working condition without event happening, placing the refrigeration surface close to the self-heating element within the wearable device and using the refrigeration surface to decrease the temperature of the self-heating element, wherein said self-heating element can be a battery or the control chip of the wearable device.

Preferably, each Peltier is constituted by several sub-Peltiers in parallel, each sub-Peltiers has a central axis, and all of the central axes of the sub-Peltiers are coplanar and in parallel with each other. In stationary, all of the heating surfaces of the sub-Peltiers are coplanar. The temperature regulating module further includes a driving device, and the control chip is configured to control the driving device to drive all of the sub-Peltiers to make them rotate around the central axes synchronously, such that the sides of all the sub-Peltiers directly contacting the contact area or contacting the contact area via the heat conductive element switch between the refrigeration surface and the heating surface.

To make the temperature of the contact area switch more rapidly to give more obvious prompt to user, each Peltier is divided into several sub-Peltiers. When the heating surfaces of the sub-Peltiers contact the contact area, the wearable device can prompt user by increasing temperature. By the sub-Peltiers rotating the refrigeration surface is approached to the contact area rapidly which makes the temperature of the contact area decrease rapidly, and the wearable device prompts user by decreasing temperature. The switching between the heating surfaces and the refrigeration surfaces can be achieved by the rotation of the sub-Peltiers.

All of the heating surfaces of the sub-Peltiers are coplanar, which means that all of the heating surfaces of the sub-Peltiers are coplanar when they contact the contact area directly or indirectly, while all of the refrigeration surfaces thereof are coplanar. That is to say, when the wearable device alerts user, all of the heating surfaces and the refrigeration surfaces are placed on the respective planes. For example, when the wearable device increases temperature as a prompt, all of the heating surfaces of the sub-Peltiers are located at the same plane, and one side of said plane is used to contact the contact area.

In addition, these synchronously rotating sub-Peltiers can be easily controlled. Specifically, the Peltier in prior art is unitary. However, in the present invention, the Peltier is constituted by several sub-Peltiers, and these sub-Peltiers can rotate in a smaller space so as to achieve fast switching between the heating surface and the refrigeration surface.

Preferably, the driving device includes a traction belt and a power device, and the power device is configured to pull the traction belt to make all of the sub-Peltiers rotate around the central axes synchronously.

The traction belt and the power device can operate to make the sub-Peltiers rotate synchronously.

Preferably, the wearable device is an intelligent watch.

The temperature detecting circuit, the temperature regulating module and the control chip are disposed inside the dial of the intelligent watch, while the contact area is disposed on the inner surface of the dial; or
the temperature detecting circuit and the temperature regulating module are disposed inside the band of the intelligent watch, and the control chip is disposed inside the dial of the intelligent watch, while the contact area is disposed on the inner surface of the band.

Preferably, the control chip is configured to, within the preset interval, control the temperature regulating module to adjust the temperature of the contact area to M+N degree Celsius or M−P degree Celsius;

M is the first temperature, and both of N and P are larger than 0 and less than or equal to 15.

By properly regulating the temperature of the contact area, user can comfortably feel the change of the temperature.

Moreover, the temperature detecting circuit is preferably NTC (short of Negative Temperature Coefficient, with the meaning of negative temperature coefficient) circuit.

The present invention further provides a wearable device, comprising: at least one contact area for contacting a wearing object, a temperature detecting circuit, at least one temperature regulating module and a control chip;
the temperature detecting circuit is configured to detect the temperature of the contact area when events happen as a first temperature;
the control chip is configured to, within a preset interval since events happen, control the temperature regulating module to increase the temperature of the contact area on the basis of the first temperature to alert events happening, and the temperature regulating module is an electric heating element.

The use of the electric heating element for increasing temperature to alert events happening can reduce the cost of the wearable device.

By utilizing the knowledge of the present technical field, the above optimum solutions can be combined to obtain the preferred embodiments of the present invention.

The present invention can use temperature regulation to alert user of events happening, the alert mode will not bring uncomfortable feeling to user when alerting events happening, and it has several alert modes to alert different events.

### BRIEF DESCRIPTION OF THE DRAWINGS

FIG. 1 is a partial structure diagram of the intelligent watch of embodiment 1 of the present invention.

FIG. 2 is a circuit diagram of the intelligent watch of embodiment 1 of the present invention.

FIG. 3 is a section view of the intelligent watch of embodiment 1 of the present invention.

FIG. 4 is a structure diagram of the intelligent watch of embodiment 2 of the present invention.

FIG. 5 is another structure diagram of the intelligent watch of embodiment 2 of the present invention.

FIG. 6 is a structure diagram of the intelligent watch of embodiment 3 of the present invention.

### DETAILED DESCRIPTION OF THE PREFERRED EMBODIMENT

### Embodiment 1

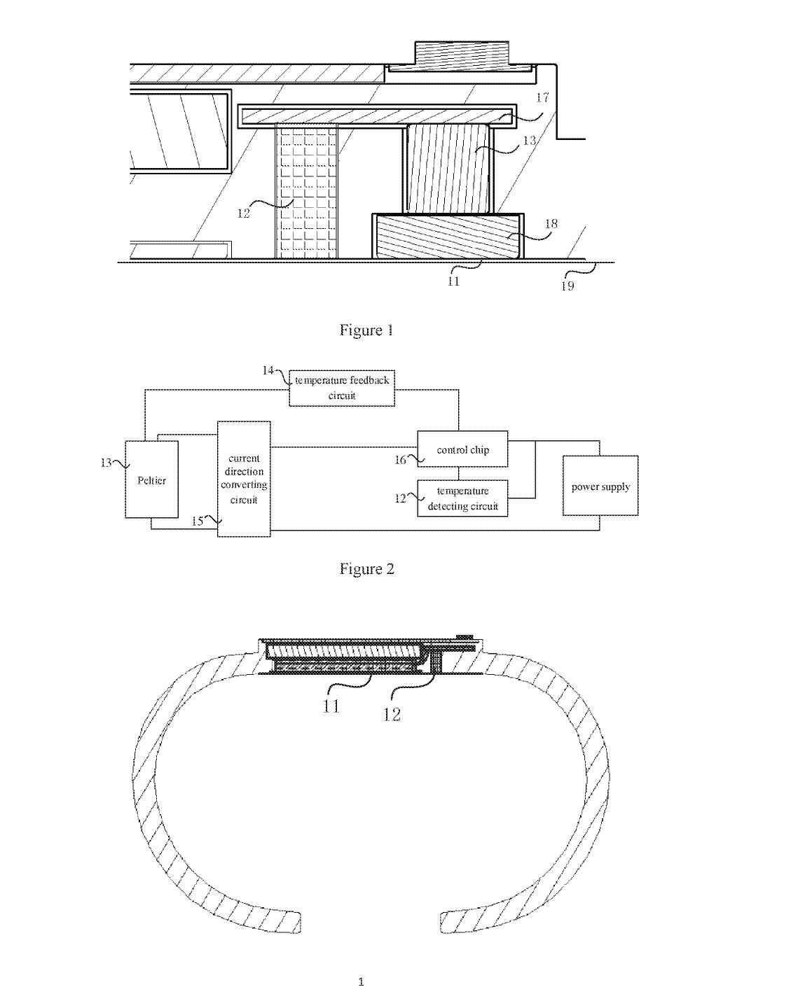

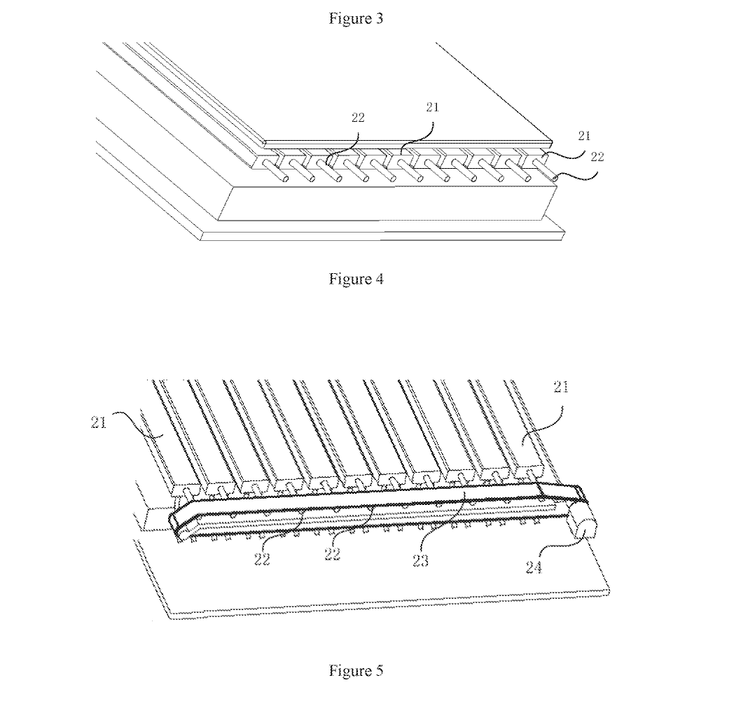

See FIG. 1, FIG. 2 and FIG. 3, this embodiment provides an intelligent watch comprising a contact area 11, a temperature detecting circuit 12, a Peltier 13, a temperature feedback circuit 14, a current direction converting circuit 15 and a control chip 16.

The temperature detecting circuit, the Peltier and the control chip are disposed inside the dial of the intelligent watch, while the contact area is disposed on the inner surface of the dial.

When user wears the intelligent watch on his/her right hand, the contact area contacts skin 19 on the wrist of right hand of user.

The temperature detecting circuit is configured to detect the temperature of the contact area when events happen as a first temperature.

The temperature feedback circuit is configured to feedback the temperature of the Peltier to the control chip. The Peltier connects to the control chip via the current direction converting circuit, and the control chip is disposed on the circuit board 17 of the intelligent watch and supplies power to the Peltier.

The control chip is configured to control the direction of the current transferred from the current direction converting circuit to the Peltier, so as to control the side of the Peltier contacting the contact area via the heat conductive element 18 to switch between the refrigeration surface and the heating surface.

The specific switching mode of the intelligent watch is:
when the intelligent watch receives a message, the control chip controls the current direction, so as to control the side of the Peltier contacting the contact area via the heat conductive element to switch into the heating surface, such that the temperature of the contact area is increased by 5 degree Celsius on the basis of the first temperature;
when the intelligent watch receives an E-mail, the control chip controls the current direction, so as to control the side of the Peltier contacting the contact area via the heat conductive element to switch into the refrigeration surface, such that the temperature of the contact area is decreased by 4 degree Celsius on the basis of the first temperature;
when the intelligent watch receives a phone call, the control chip controls the current direction converting circuit to make it convert the direction of the current transferred to the Peltier every five seconds, so as to control the side of the Peltier contacting the contact area via the heat conductive element to switch between the refrigeration and the heating every five seconds, until that user answers the phone call or the phone call is hung up.

The alert mode of the intelligent watch of the present embodiment can be set by user, and user can set the increasement of the temperature on the contact area as an alert of receiving a message, or set the decreasement of the temperature on the contact area as an alert of receiving a message.

The intelligent watch of the present embodiment can use temperature regulation to alert user of events happening, which will not bring uncomfortable feeling to user when alerting events happening, and it has several alert modes to alert different events.

### Embodiment 2

See FIG. 4 and FIG. 5, the intelligent watch of the present embodiment is substantially the same as that of embodiment 1, while the difference merely lies in:

The temperature detecting circuit and the temperature regulating module are disposed inside the band of the intelligent watch, the control chip is disposed inside the dial of the intelligent watch, and the contact area is disposed on the inner surface of the band.

Each Peltier is constituted by several sub-Peltiers 21 in parallel, and each sub-Peltier 21 has a central axis 22. All of the central axes 22 of the sub-Peltiers 21 are coplanar and in parallel with each other, and all of the heating surfaces of the sub-Peltiers 21 are coplanar.

The intelligent watch further includes a driving device, and the driving device includes a traction belt 23 and a power device 24. The control chip is configured to control the power device to pull the traction belt to make all of the sub-Peltiers rotate around the central axes 22 synchronously, such that the sides of all the sub-Peltiers directly contacting the contact area switch between the refrigeration surface and the heating surface.

The specific switching mode of the intelligent watch is:
when the intelligent watch receives a message, the control chip controls the power device to pull the traction belt to make all of the sub-Peltiers rotate around the central axes 22 synchronously, such that the sides of all the sub-Peltiers directly contacting the contact area are the heating surfaces, thus the temperature of the contact area is increased by 5 degree Celsius on the basis of the first temperature;
when the intelligent watch receives an E-mail, the control chip controls the power device to pull the traction belt to make all of the sub-Peltiers rotate around the central axes 22 synchronously, such that the sides of all the sub-Peltiers directly contacting the contact area are refrigeration surfaces, thus the temperature of the contact area is decreased by 5 degree Celsius on the basis of the first temperature;

when the intelligent watch receives a phone call, the control chip controls the power device to pull the traction belt to make all of the sub-Peltiers rotate synchronously around the central axes 22 in 180 degrees and negative 180 degrees alternatively every five seconds, such that the sides of all the sub-Peltiers directly contacting the contact area switch every five seconds, thus the temperature of the contact area is increased and decreased alternatively on the basis of the first temperature, until user answers the phone call or the phone call is hung up.

The intelligent watch of the present embodiment can use temperature regulation to alert user of events happening, which will not bring uncomfortable feeling to user when alerting events are happening, and it has several alert modes to alert different events. In particular, the Peltier is constituted by several sub-Peltiers, and they can rotate in a smaller space, thus making the temperature of the contact area switch more rapidly to give more obvious prompt to user.

### Embodiment 3

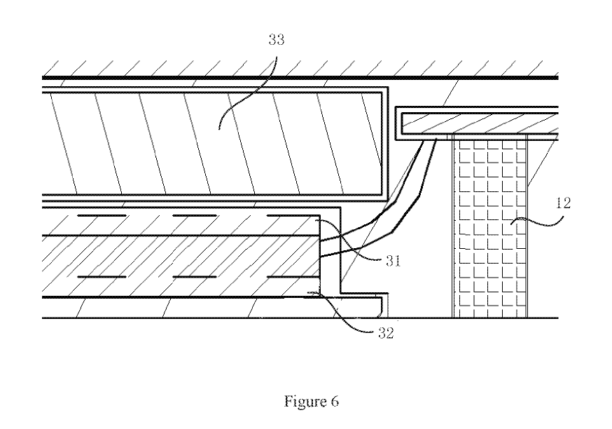

See FIG. 6, the intelligent watch of the present embodiment is substantially the same as that of embodiment 1, while the difference merely lies in:

The intelligent watch includes a moving device and the control chip is configured to control the Peltier to work continuously, wherein:
when no event happens, control the moving device to retain the Peltier in such condition: the refrigeration surface of the Peltier is relatively close to the battery within the wearable device, and the heating surface thereof is relatively far away from the contact area;
when events happen, control the moving device to place the Peltier to make the heating surface of the Peltier contact the contact area directly.

The specific operating mode of the intelligent watch is:
when the intelligent watch is in standby condition, numeral 31 indicates the position of the Peltier, and the control chip controls the current direction so as to control the side of the Peltier close to the contact area to switch into the heating surface, and places the heating surface away from the contact area, and places the refrigeration surface to approach the battery 33 within the intelligent watch to decrease the temperature of the battery 33;
when the intelligent watch receives a message, numeral 32 indicates the position of the Peltier, and the control chip controls the moving device to place the heating surface of the Peltier to contact the contact area directly, such that the temperature of the contact area is increased by 5 degree Celsius on the basis of the first temperature.

The intelligent watch of the present embodiment can use temperature regulation to alert user of events happening, which will not bring uncomfortable feeling to the user when alerting of events happening, and it has several alert modes to alert different events. In particular, the present embodiment can increase the temperature of the contact area rapidly, and make the component inside the intelligent watch operate under lower temperature, thus improving the performance of the intelligent watch.

### Embodiment 4

The present embodiment provides a pair of intelligent glasses, comprising two contact areas, a temperature detecting circuit, two Peltiers, two temperature feedback circuits, a current direction converting circuit and a control chip.

The temperature detecting circuit, the temperature regulating module and the control chip are disposed inside side-arms of the intelligent glasses. The contact areas are respectively disposed on inner surfaces of distal ends of two side-arms.

When user wears the intelligent glasses, the contact areas contact the upper portion of user's ear.

The temperature detecting circuit is configured to detect the temperature of the contact area when events happen as a first temperature.

The temperature feedback circuits are configured to feedback the temperatures of the Peltiers to the control chip, the two Peltiers are reversely paralleled and connected to the control chip via the current direction converting circuit, and the control chip is disposed on the circuit board of the intelligent glasses and used for supplying power to the Peltiers.

The control chip is further configured to control the direction of the current transferred from the current direction converting circuit to the Peltiers, so as to control the sides of the Peltiers directly contacting the contact area to switch between the heating surface and the refrigeration surface.

Two Peltiers include a first Peltier and a second Peltier, the specific switching mode of the intelligent glasses is:
when the intelligent glasses receives a message, the control chip controls the current direction, so as to control the side of the first Peltier directly contacting the contact area to switch into the heating surface, such that the temperature of the contact area is increased by 5 degree Celsius on the basis of the first temperature;

Since the second Peltier is reversely paralleled with the first Peltier, the side of the second Peltier directly contacting the contact area switches into the refrigeration surface, such that the temperature of the contact area is decreased by 5 degree Celsius on the basis of the first temperature.

The intelligent glasses of the present embodiment can use temperature regulation to alert user of events happening, which will not bring uncomfortable feeling to user when alerting events happening, and it has several alert modes to alert different events. In particular, two side-arms alert user with different modes to make user perceive the event easily.

### Embodiment 5

The intelligent glasses of the present embodiment is substantially the same as that of embodiment 4, while the difference merely lies in:

The temperature feedback circuits are configured to feedback the temperature of the Peltiers to the control chip. The two Peltiers are paralleled and connected to the control chip via the current direction converting circuit, and the control chip is disposed on the circuit board of the intelligent glasses and used for supplying power to the Peltiers.

Since the second Peltier is paralleled with the first Peltier, the first Peltier and the second Peltier are heated or refrigerated simultaneously, such that the temperature of the contact area is decreased by 5 degree Celsius or increased by 5 degree Celsius on the basis of the first temperature.

### Embodiment 6

The present embodiment provides an intelligent watch comprising a contact area, a NTC circuit, an electric heating element and a control chip.

The NTC circuit, the electric heating element and the control chip are disposed inside the dial of the intelligent watch, while the contact area is disposed on the inner surface of the dial.

The NTC circuit is configured to detect the temperature of the contact area as a first temperature when events happen.

The electric heating element connects to the control chip. The control chip is disposed on the circuit board of the intelligent watch, and after events happen it is configured to control the electric heating element to change temperature such that the temperature of the contact area increases on the basis of the first temperature as an alert of events happening.

The present embodiment can alert user of events happening, while it can be manufactured with lower cost.

Although the specific embodiments of the present invention are described as above, they are exemplary. Those skilled in the art can make various change or modification without deviating the principle and spirit of the present invention. Therefore, the protect scope of the invention is defined by claims.

1. A wearable device, comprising: at least one contact area for contacting a wearing object, a temperature detecting circuit, at least one temperature regulating module and a control chip,
the temperature detecting circuit is configured to detect the temperature of the contact area when events happen as a first temperature;
the control chip is configured to, within a preset interval since events happen, control the temperature regulating module to change the temperature of the contact area on the basis of the first temperature to notice events happening.

2. The wearable device according to claim 1, wherein the temperature regulating module includes a temperature regulating component, which contacts the contact area via a heat conductive element or contacts the contact area directly.

3. The wearable device according to claim 1, wherein the wearable device further includes at least one temperature feedback circuit, the temperature regulating module includes at least one Peltier, the temperature feedback circuit is configured to feedback the temperature of the Peltier to the control chip, and the control chip is further configured to supply power to the Peltier.

4. The wearable device according to claim 3, wherein the temperature regulating module further comprises a current direction converting circuit, the Peltier connects to the control chip via the current direction converting circuit, and the control chip is configured to control the direction of current transferred from the current direction converting circuit to the Peltier, so as to control the side of the Peltier directly contacting the contact area or contacting the contact area via the heat conductive element to switch between the refrigeration surface and the heating surface.

5. The wearable device according to claim 4, wherein the temperature regulating module further includes a moving device and the control chip is configured to control the Peltier to work continuously, wherein:
when no event happens, control the moving device to retain the Peltier in such condition: the refrigeration surface of the Peltier is relatively close to a self-heating element within the wearable device, and the heating surface thereof is relatively far away from the contact area or the heat conductive element;
when events happen, control the moving device to place the Peltier to make the heating surface of the Peltier contact the contact area directly or contact the contact area via the heat conductive element.

6. The wearable device according to claim 3, wherein each Peltier is constituted by several sub-Peltiers in parallel, each sub-Peltier has a central axis, all of the central axes of the sub-Peltier are coplanar and in parallel with each other, in stationary, all of the heating surfaces of the sub-Peltiers are coplanar, the temperature regulating module further includes a driving device, the control chip is configured to control the driving device to drive all of the sub-Peltiers to make them rotate around the central axes synchronously, such that the sides of all the sub-Peltiers directly contacting the contact area or contacting the contact area via the heat conductive element switch between the refrigeration surfaces and the heating surfaces.

7. The wearable device according to claim 6, wherein the driving device includes a traction belt and a power device, the power device is configured to pull the traction belt to make all of the sub-Peltiers rotate around the central axes synchronously.

8. The wearable device according to claim 1, wherein the wearable device is an intelligent watch,
the temperature detecting circuit, the temperature regulating module and the control chip is disposed inside the dial of the intelligent watch, and the contact area is disposed on the inner surface of the dial; or
the temperature detecting circuit and the temperature regulating module are disposed inside the band of the intelligent watch, the control chip is disposed inside the dial of the intelligent watch, and the contact area is disposed on the inner surface of the band.

9. The wearable device according to claim 1, wherein the control chip is configured to, within the preset interval, control the temperature regulating module to adjust the temperature of the contact area to M+N degree Celsius or M−P degree Celsius;
wherein, M is the first temperature, and both of N and P are larger than 0 and less than or equal to 15.

10. A wearable device, comprising: at least one contact area for contacting a wearing object, a temperature detecting circuit, at least one temperature regulating module and a control chip;
the temperature detecting circuit is configured to detect the temperature of the contact area when events happen as a first temperature;
the control chip is configured to, within a preset interval since events happen, control the temperature regulating module to increase the temperature of the contact area on the basis of the first temperature to alert events happening, and the temperature regulating module is an electric heating element.

11. The wearable device according to claim 2, wherein the wearable device is an intelligent watch,
the temperature detecting circuit, the temperature regulating module and the control chip are disposed inside the dial of the intelligent watch, and the contact area is disposed on the inner surface of the dial; or
the temperature detecting circuit and the temperature regulating module are disposed inside the band of the intelligent watch, the control chip is disposed inside the dial of the intelligent watch, and the contact area is disposed on the inner surface of the band.

12. The wearable device according to claim 3, wherein the wearable device is an intelligent watch,
the temperature detecting circuit, the temperature regulating module and the control chip are disposed inside the dial of the intelligent watch, and the contact area is disposed on the inner surface of the dial; or
the temperature detecting circuit and the temperature regulating module are disposed inside the band of the intelligent watch, the control chip is disposed inside the dial of the intelligent watch, and the contact area is disposed on the inner surface of the band.

13. The wearable device according to claim 4, wherein the wearable device is an intelligent watch,
the temperature detecting circuit, the temperature regulating module and the control chip are disposed inside the dial of the intelligent watch, and the contact area is disposed on the inner surface of the dial; or
the temperature detecting circuit and the temperature regulating module are disposed inside the band of the intelligent watch, the control chip is disposed inside the dial of the intelligent watch, and the contact area is disposed on the inner surface of the band.

14. The wearable device according to claim 5, wherein the wearable device is an intelligent watch,
the temperature detecting circuit, the temperature regulating module and the control chip are disposed inside the dial of the intelligent watch, and the contact area is disposed on the inner surface of the dial; or
the temperature detecting circuit and the temperature regulating module are disposed inside the band of the intelligent watch, the control chip is disposed inside the dial of the intelligent watch, and the contact area is disposed on the inner surface of the band.

15. The wearable device according to claim 6, wherein the wearable device is an intelligent watch,
the temperature detecting circuit, the temperature regulating module and the control chip are disposed inside the dial of the intelligent watch, and the contact area is disposed on the inner surface of the dial; or
the temperature detecting circuit and the temperature regulating module are disposed inside the band of the intelligent watch, the control chip is disposed inside the dial of the intelligent watch, and the contact area is disposed on the inner surface of the band.

16. The wearable device according to claim 7, wherein the wearable device is an intelligent watch,
the temperature detecting circuit, the temperature regulating module and the control chip are disposed inside the dial of the intelligent watch, and the contact area is disposed on the inner surface of the dial; or
the temperature detecting circuit and the temperature regulating module are disposed inside the band of the intelligent watch, the control chip is disposed inside the dial of the intelligent watch, and the contact area is disposed on the inner surface of the band.
